(19) United States
(12) Patent Application Publication
(10) Pub. No.: US 2023/0198048 A1
(43) Pub. Date: Jun. 22, 2023

(54) BATTERY HEAT EXCHANGE STRUCTURE

(71) Applicant: SANKEI GIKEN KOGYO CO., LTD., Tokyo (JP)

(72) Inventors: Keisuke Nakamura, Isesaki-shi, Gunma (JP); Takanori Nagai, Isesaki-shi, Gunma (JP)

(73) Assignee: SANKEI GIKEN KOGYO CO., LTD., Tokyo (JP)

(21) Appl. No.: 18/015,184

(22) PCT Filed: Jun. 10, 2021
(86) PCT No.: PCT/JP2021/022224

§ 371 Date: Jan. 9, 2023

(30) Foreign Application Priority Data
Jul. 10, 2020 (JP) 2020-119464

(51) Int. Cl. H01M 10/6556; H01M 10/6568; H01M 10/613; H01M 10/658; H01M 10/48; H01M 10/63

(52) U.S. Cl. CPC H01M 10/6556; H01M 10/63; H01M 10/486; H01M 10/613; H01M 10/658; H01M 10/6568

(57) ABSTRACT

In this battery heat exchange structure: a battery cell and a heat exchange panel are closely arranged side by side so that a heat exchange surface of the heat exchange panel follows a side surface of the battery cell, a flow path wall defining a flow path through which a refrigerant circulates along the heat exchange surface is provided in the heat exchange panel, and a storage space surrounded by the flow path wall is filled with a latent heat storage material that undergoes a phase change at a temperature lower than a temperature of the refrigerant F when the refrigerant is supplied. As a result, the heat exchange efficiency between the heat exchange panel and the battery cell can be increased, and the temperature of the battery can be controlled to be within an appropriate temperature range.

### TECHNICAL FIELD

The present invention relates to a battery heat exchange structure that exchanges heat with a battery of an electric vehicle or the like.

### BACKGROUND ART

Conventionally, as a structure for exchanging heat with an automobile battery, a structure in which a refrigerant circuit for extracting heat from the battery is provided, heat is transferred through the refrigerant, and the transferred heat is supplied to an air conditioner is known (see Patent Literatures 1 and 2).

### CITATION LIST

### Patent Literature

PTL 1] Japanese Patent Application Publication No. 2011-230648
PTL 2] Japanese Patent Application Publication No. 2015-182487

### SUMMARY OF INVENTIONS

### Technical Problem

By the way, in order to efficiently extract and collect the heat from the battery for the purpose of effectively utilizing the heat as in Patent Literatures 1 and 2, it is necessary to install a heat exchange structure having high heat exchange efficiency in the battery.

In addition, the battery has a problem that the output voltage and the discharge capacity decrease and the battery performance decreases temporarily in a low-temperature external environment due to cold weather or cold regions. On the other hand, the battery has another problem that the permanent performance of the battery deteriorates and the battery life is shortened when the high temperature state continues. Therefore, a structure capable of controlling the temperature of the battery to be in an appropriate temperature range is also required.

The present invention is proposed in view of the above problems, and an object thereof is to provide a battery heat exchange structure capable of increasing the heat exchange efficiency between a heat exchange panel and a battery cell and controlling the temperature of the battery to be within an appropriate temperature range.

### Solution to Problem

In a battery heat exchange structure of the present invention, a battery cell and a heat exchange panel are closely arranged side by side so that a heat exchange surface of the heat exchange panel follows a side surface of the battery cell, a flow path wall defining a flow path through which a refrigerant circulates along the heat exchange surface is provided in the heat exchange panel, and a storage space surrounded by the flow path wall is filled with a latent heat storage material that undergoes a phase change at a temperature lower than the temperature of the refrigerant when the refrigerant is supplied.

According to this configuration, since the battery cell and the heat exchange panel are in close contact with each other so that the side surface of a necessary battery cell follows the heat exchange surface of the heat exchange panel, heat exchange between the latent heat storage material in the heat exchange panel and the battery cell and between the battery cell and the refrigerant circulating through the heat exchange panel can be performed with high heat exchange efficiency. Furthermore, at low temperatures, excessive temperature drops in the battery cells can be suppressed by exchanging heat with the heat released by the phase change of the latent heat storage material, and a temporary decrease in battery performance due to a decrease in output voltage and a decrease in discharge capacity can be prevented. In addition, at high temperatures, excessive temperature rise in the battery cells can be suppressed by exchanging heat with the refrigerant circulating through the heat exchange panel, and permanent deterioration of battery performance and shortening of battery life can be prevented. That is, the temperature of the battery can be controlled to be within an appropriate temperature range.

In the battery heat exchange structure of the present invention, the flow path has three or more branch flow paths, each of the branch flow paths is provided so as to circulate the refrigerant along the heat exchange surface, and the storage space filled with the latent heat storage material is provided at least between the branch flow paths.

According to this, with respect to the heat exchange surface of the heat exchange panel, for example, the region corresponding to the arrangement of the latent heat storage material, such as a latent heat storage material having a lower thermal conductivity than the refrigerant, can be more evenly distributed, and the region corresponding to the circulation of the refrigerant can be more evenly distributed. Furthermore, the heat exchange that suppresses an excessive temperature drop at low temperatures and the heat exchange that suppresses an excessive temperature rise at high temperatures can be performed more reliably. Therefore, the temperature of the battery can be reliably controlled to be within an appropriate temperature range. In addition, since the latent heat storage material is arranged in a wide range or in a plurality of region with a more even distribution, even when a latent heat storage material with poor thermal conductivity is used, the capacity of the latent heat storage material can be maximized.

In the battery heat exchange structure of the present invention, the heat exchange panel and the battery cells are elastically urged so as to be compressed in the arrangement direction of the heat exchange panel and the battery cell.

According to this configuration, the heat exchange panel and the battery cell are elastically urged so as to be compressed and pressed in the arrangement direction, the heat exchange efficiency between the latent heat storage material in the heat exchange panel and the battery cell and between the battery cell and the refrigerant circulating through the heat exchange panel can be further improved, and the stability of heat exchange can be enhanced. In addition, since the heat exchange panel and the battery cell are elastically urged in the arrangement direction, it is possible to secure a state in which the heat exchange panel and the battery cell are pressed in the arrangement direction following the thermal expansion of the battery and the contraction when the temperature drops. In addition, since the heat exchange panel and the battery cell are elastically urged in the arrangement direction, it is possible to absorb the amount of expansion during thermal expansion of the battery, prevent damage to the heat exchange structure due to an increase in internal pressure, and improve safety.

In the battery heat exchange structure of the present invention, a battery body including the battery cell and the heat exchange panel, and a support portion supporting the battery body are housed in a heat insulating container.

According to this, since the battery body is housed in the insulating container, the influence of the temperature of the external environment on the battery can be reduced, and the range of the low temperature level that can be handled in a low-temperature external environment and the range of the high temperature level that can be handled in a high-temperature external environment can be extended. Furthermore, the temperature range in which the temperature of the battery can be controlled to be within an appropriate temperature range can be extended. In addition, when the battery body is equipped with a protection circuit that regulates the output at a very high temperature, it is possible to prevent the protection circuit from operating unexpectedly at a very high temperature in the summer.

In the battery heat exchange structure of the present invention, a temperature sensor for detecting a temperature of the battery cell is provided close to the battery cell, and a refrigerant control unit supplies the refrigerant having a required temperature according to a detection temperature from the temperature sensor.

According to this configuration, the refrigerant having a required temperature can be circulated as necessary according to the detection temperature from the temperature sensor, and the temperature of the battery can be automatically controlled to be in an appropriate temperature range.

### Advantageous Effects of Invention

According to the battery heat exchange structure of the present invention, the heat exchange efficiency between the heat exchange panel and the battery cell can be increased, and the temperature of the battery can be controlled to be in an appropriate temperature range.

### BRIEF DESCRIPTION OF DRAWINGS

FIG. 1 is a plan view of a battery insulation structure according to an embodiment of the present invention.

FIG. 2 is an enlarged cross-sectional view taken along the line A-A in FIG. 1.

FIG. 3 is an enlarged view along the line B-B in FIG. 2.

FIG. 4 is an enlarged view of the part C in FIG. 3.

FIG. 5 is a longitudinal explanatory view of a heat exchange panel in the battery heat exchange structure of the embodiment.

FIG. 6 is a block diagram showing a battery heat exchange structure and a refrigerant control configuration according to the embodiment.

### DESCRIPTION OF EMBODIMENTS

### Battery Heat Exchange Structure of Embodiment

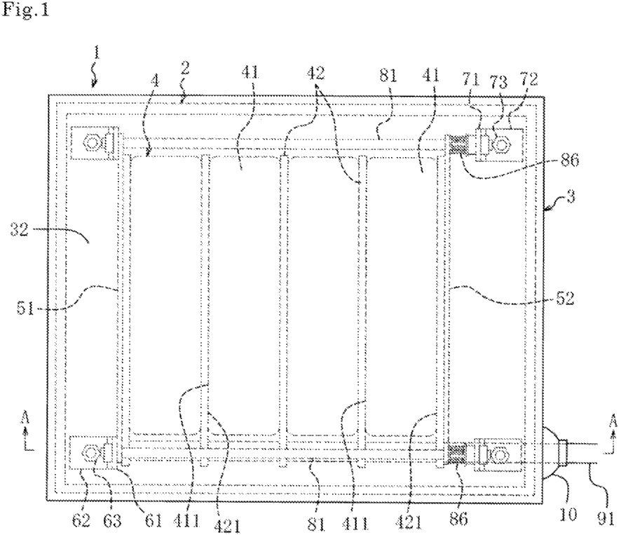

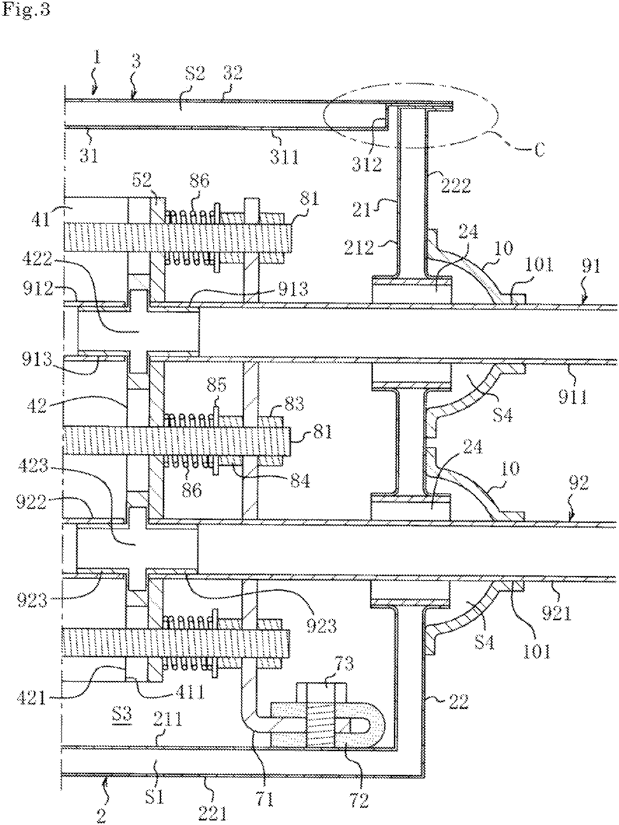

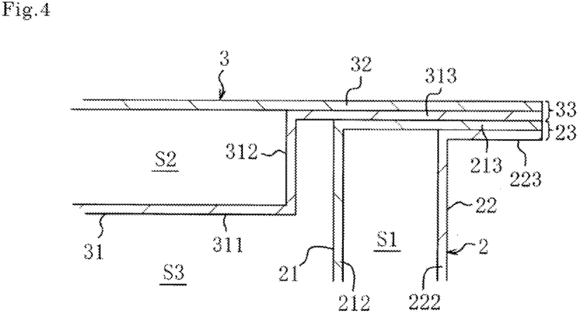

As shown in FIGS. 1 to 4, a battery heat exchange structure of an embodiment according to the present invention includes a double-walled insulating container 1 composed of an insulating container main body 2 and an insulating lid 3, and a battery body 4 housed in the insulating container 1. In the battery body 4, as will be described later, heat exchange is performed between a battery cell 41 and a latent heat storage material 427 in a heat exchange panels 42, and between the battery cell 41 and the refrigerant F flowing through the heat exchange panel 42.

The insulating container main body 2 is formed in a substantially rectangular box shape with an open upper surface, and has a double-wall structure including a substantially rectangular box-shaped inner wall 21 with an open upper surface and a substantially rectangular box-shaped outer wall 22 with an open upper surface. A bottom portion 211 of the inner wall 21 and a bottom portion 221 of the outer wall 22, and a peripheral side portion 212 of the inner wall 21 and a peripheral side portion 222 of the outer wall 22 are arranged to be spaced apart from each other, and an insulating space S1 is provided between the inner wall 21 and the outer wall 22. The insulating space S1 is preferably a vacuumed decompression space, but it can also be an air layer, and the insulating space S1 of the present embodiment is hollow but a solid insulating material may be filled in the insulating space S1.

A flat flange 213 protruding outward is formed at the upper end of the peripheral side portion 212 of the inner wall 21, and a flat flange 223 protruding outward is formed at the upper end of the peripheral side portion 22 of the outer wall 22. The flange 213 is overlapped so as to be placed on the flange 223, the ends of the inner wall 21 and the outer wall 22 are sealed, and the flanges are fixed by welding or the like at the overlapping position, whereby a container-side flat flange 23 is formed.

The insulating lid 3 is formed in a substantially flat plate shape, and has a double-wall structure including a thin dish-shaped inner lid 31 whose center is recessed from the peripheral edge and a flat plate-shaped outer lid 32. The inner lid 31 has a substrate 311 and an erected portion 312 that stands around the substrate 311 and a flange 313 that protrudes outward from the upper end of the erected portion 312. The substrate 311 of the inner lid 31 and the outer lid 32 are arranged to be spaced apart from each other, and an insulating space S2 is provided between the substrate 311 of the inner lid 31 and the outer lid 32, in other words, between the inner lid 31 and the outer lid 32. The insulating space S2 is also preferably a vacuumed decompression space, but it can also be an air layer, and the insulating space S2 of the present embodiment is hollow but a solid insulating material may be filled in the insulating space S2.

The outer lid 32 is overlapped so as to be placed on the flange 313 of the inner lid 31. The ends of the inner lid 31 and the outer lid 32 are sealed, and the lids are fixed by welding or the like at the position where the outer lid 32 is overlapped with the flange 313 of the inner lid 31, whereby a lid-side flat flange 33 is formed.

The insulating container 1 is closed in such a way that a lower surface of the lid-side flat flange 33 having a planar area equal to or larger than the container-side flat flange 23 of the insulating lid 3 is overlapped so as to be placed on an upper surface of the container-side flat flange 23 having a planar area larger than the planar area at the upper end position of the insulating space S1 of the insulating container main body 2 and the insulating lid 3 engages with the insulating container main body 2. The container-side flat flange 23 and the lid-side flat flange 33, which are overlapped in a state where the planar contact area is larger than the planar area at the upper end position of the insulating space S1, are detachably fixed by fixing members such as bolts and nuts (not shown).

By closing the insulating container 1 by increasing the mutual contact area at the contact position of the insulating container main body 2 and the insulating lid 3, the airtightness, the sealing property, and the insulating property at the contact position between the insulating container main body 2 and the insulating lid 3 can be improved. It is also preferable to provide a sealing material between the container-side flat flange 23 and the lid-side flat flange 33, and to place the lid-side flat flange 33 on the container-side flat flange 23 via the sealing material interposed therebetween.

The outer peripheral dimensions of the substrate 311 and the erected portion 312 of the inner lid 31 of the insulating lid 3 are formed to be slightly smaller than the inner peripheral dimension at the upper end position of the inner wall 21 of the insulating container main body 2. In the closed state of the insulating container 1, the substrate 311 and the erected portion 312 of the inner lid 31 of the insulating lid 3 are tightly or loosely fitted inside the inner wall 21 of the insulating container main body 2, and the insulating lid 3 engages with the insulating container main body 2.

The battery body 4 of the present embodiment has a plurality of battery cells 41 provided side by side at predetermined intervals, and heat exchange panels 42 provided on both sides of each battery cell 41 in the arrangement direction. The battery body 4 has a stacked structure in which the battery cell 41 and the heat exchange panel 42 are closely and alternately stacked. In the battery body 4, the battery cell 41 and the heat exchange panel 42 are closely and alternately arranged side by side so that the heat exchange surface 421 of the heat exchange panel 42 follows the side surface 411 of the battery cell 41.

Holding plates 51 and 52 are provided on the outer sides of the heat exchange panels 42 and 42 located at both ends in the arrangement direction of the battery cell 41 of the battery body 4 and the heat exchange panel 42. In other words, the battery cell 41 and the heat exchange panel 42 are closely and alternately arranged side by side between one holding plate 51 provided at one end in the arrangement direction of the battery cell 41 and the heat exchange panel 42 and the other holding plate 52 provided at the other end. The battery cell 41 and the heat exchange panel 42 are installed in the insulating container 1 so as to be sandwiched between the holding plates 51 and 52.

A side portion of a substantially L-shaped support stay 61 is arranged adjacent to the outer side of the holding plate 51 on one side in the arrangement direction of the battery cell 41 and the heat exchange panel 42, and the lower portion of the support stay 61 is engaged with an insulating material 62 such as an insulating rubber having a substantially U-shaped cross-section fixed to the bottom portion 211 of the inner wall 21 of the insulating container main body 2 and is fixed to the insulating material 62 by tightening a bolt 63. That is, the battery body 4 sandwiched between the holding plates 51 and 52 is installed with the insulating material 62 fixed to the inner wall 21 of the insulating container main body 2 interposed therebetween. The support stay 61, the insulating material 62, and the bolt 63 are arranged near both ends of the holding plate 51 on one side in a direction orthogonal to the arrangement direction of the battery cell 41 and the heat exchange panel 42 in the plan view of the insulating container 1.

Side portions of a substantially L-shaped support stay 71 are arranged at an interval from the holding plate 52 on the outer side of the holding plate 52 on the other side in the arrangement direction of the battery cell 41 and the heat exchange panel 42, and the lower portion of the support stay 71 is also engaged with an insulating material 72 such as an insulating rubber having a substantially U-shaped cross-section fixed to the bottom portion 211 of the inner wall 21 of the insulating container main body 2 and is fixed to the insulating material 72 by fastening a bolt 73. That is, the battery body 4 sandwiched between the holding plates 51 and 52 is installed with the insulating material 72 fixed to the inner wall 21 of the insulating container main body 2 interposed therebetween. The support stay 71, the insulating material 72, and the bolt 73 are arranged at positions corresponding to both ends of the holding plate 52 on the other side in a direction orthogonal to the arrangement direction of the battery cell 41 and the heat exchange panel 42 in the plan view of the insulating container 1.

A shaft bolt 81 is provided so as to penetrate the support stay 61, the holding plate 51, the holding plate 52, and the support stay 71. The shaft bolts 81 are provided on both sides of a direction orthogonal to the arrangement direction of the battery cell 41 and the heat exchange panel 42, and in the shown example, the shaft bolts 81 are provided at three locations in the vertical direction, which means a total of six shaft bolts 81 are provided. A nut 82 is screwed into the shaft bolt 81 in close contact with the support stay 61 on the outer side of the support stay 61, a nut 83 is screwed in close contact with the support stay 71 on the outer side of the support stay 71, and a nut 84 is screwed in close contact with the support stay 71 on the inner side of the stay 71. A washer 85 is arranged on the holding plate 52 side of the nut 84.

A coil spring 86 is provided as an elastic material between the washer 85 and the holding plate 52, and the coil spring 86 is externally inserted to the outer periphery of the shaft bolt 81. The coil spring 86 presses and urges the holding plate 52 toward the holding plate 51 by elastic restoration, whereby the battery body 4 in which the battery cell 41 and the heat exchange panel 42 are closely and alternately stacked is sandwiched between the holding plate 51 and the holding plate 52 by the urging force. In other words, the heat exchange panel 42 and the battery cell 41 are provided so as to be elastically urged to be compressed in the arrangement direction.

A plurality of coil springs 86 in the present embodiment are provided so as to correspond to positions corresponding to the vicinities of the four corners of the substantially rectangular holding plates 51 and 52 and the substantially rectangular heat exchange panel 42 provided to be overlapped so as to correspond to the positions of the four corners thereof and substantially intermediate positions near the four corners. The coil springs 86 are arranged at well-balanced intervals with respect to the heat exchange surface 421 of the heat exchange panel 42. The battery cells 41 and the heat exchange panel 42 arranged side by side so that the compressive force is applied substantially uniformly to the heat exchange surface 421 of the heat exchange panel 42 are urged by the plurality of coil springs 86 arranged at well-balanced intervals. The coil spring 86 also has a function of absorbing the expansion amount due to the thermal expansion by contraction deformation while maintaining the sandwiching state of the battery body 4 when the battery cell 41 thermally expands due to heat generation.

In the present embodiment, the elastic coil spring 86 is provided on the outer side of the other holding plate 52 as the outer side of one holding plate to urge the battery cell 41 and the heat exchange panel 42 arranged side by side. However, the elastic coil spring 86 may be provided on the outer side of one holding plate 51 on the opposite side to urge the battery cell 41 and the heat exchange panel 42 arranged side by side. Alternatively, the elastic coil spring 86 may be provided on both outer sides of both holding plates 51 and 52 to urge the battery cell 41 and the heat exchange panel 42 arranged side by side. In addition, as the elastic material for urging the battery cell 41 and the heat exchange panel 42 arranged side by side, a spring, a rubber material, or the like other than the coil spring 86 can be appropriately used.

The battery body 4 including the battery cell 41 and the heat exchange panel 42, the holding plates 51 and 52 corresponding to the support portion for supporting the battery body 4, the support stays 61 and 71, the insulating materials 62 and 72, the bolts 63 and 73, the shaft bolt 81, the nuts 82, 83, and 84, the washer 85, and the coil spring 86 are housed in the insulating container 1. The battery body 4 supported by the urging of the coil spring 86 and the sandwiching of the holding plates 51 and 52 are arranged to be spaced apart from the inner wall 21 of the insulating container main body 2 and the inner lid 31 of the insulating lid 3, and an insulating space S3 is also formed inside the insulating container 1.

In the battery heat exchange structure of the present embodiment, a fluid supply pipe 91 for supplying the refrigerant F to the heat exchange panel 42 and a fluid discharge pipe 92 for discharging the refrigerant F from the heat exchange panel 42 are provided so as to penetrate the inner wall 21 and the outer wall 22 of the insulating container main body 2. The portion of the fluid supply pipe 91 arranged in the insulating container 1 corresponding to a portion of the fluid supply pipe 91 and the portion of the fluid discharge pipe 92 arranged in the insulating container 1 corresponding to a portion of the fluid discharge pipe 92 are arranged so as to follow the arrangement direction of the battery cell 41 and the heat exchange panel 42 and are provided in parallel to the arrangement direction.

The fluid supply pipe 91 includes a fluid introduction pipe 911, a connecting pipe 912 composed of an elastic tube such as a rubber tube that can be elastically restored and stretched, and a protruding pipe 913 that protrudes in the panel normal direction from the inlet port of the heat exchange panel 42. The fluid introduction pipe 911 is composed of an elastic tube such as a rubber tube that can be elastically restored and stretched, and is externally inserted and attached to the protruding pipe 913 of the heat exchange panel 42 that is arranged at the nearest position. The protruding pipes 913 and 913 of the heat exchange panels 42 and 42 arranged side by side are connected to each other via the connecting pipe 912, and both ends of the connecting pipe 912 are externally inserted and attached to the protruding pipe 913. That is, the portion of the fluid supply pipe 91 between the heat exchange panels 42 and 42 is configured by the elastic connecting pipe 912. The connecting pipe 912 composed of an elastic tube elastically expands to follow thermal expansion when the battery cell 41 thermally expands due to heat generation, and elastically restores according to the convergence of the thermal expansion to be adaptable to the thermal expansion.

The fluid discharge pipe 92 includes a fluid lead-out pipe 921, a connecting pipe 922 composed of an elastic tube such as a rubber tube that can be elastically restored and stretched, and a protruding pipe 923 that protrudes in the panel normal direction from the outlet port of the heat exchange panel 42. The fluid lead-out pipe 921 is also composed of an elastic tube such as a rubber tube that can be elastically restored and stretched, and is externally inserted and attached to the protruding pipe 923 of the heat exchange panel 42 that is arranged at the nearest position. The protruding pipes 923 and 923 of the heat exchange panels 42 and 42 arranged side by side are connected to each other via the connecting pipe 922, and both ends of the connecting pipe 922 are externally inserted and attached to the protruding pipe 923. That is, the portion of the fluid discharge pipe 92 between the heat exchange panels 42 and 42 is configured by the elastic connecting pipe 922. The connecting pipe 922 composed of an elastic tube elastically expands to follow thermal expansion when the battery cell 41 thermally expands due to heat generation, and elastically restores according to the convergence of the thermal expansion to be adaptable to the thermal expansion.

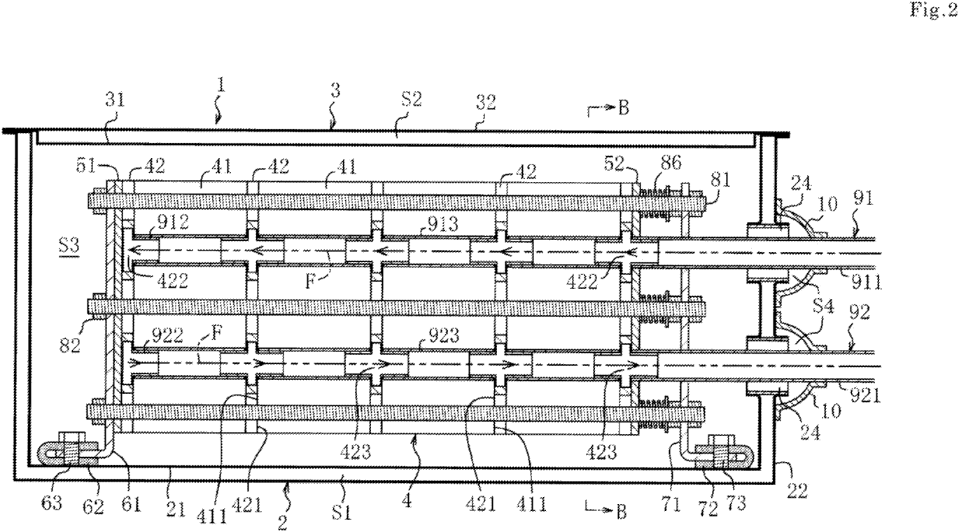

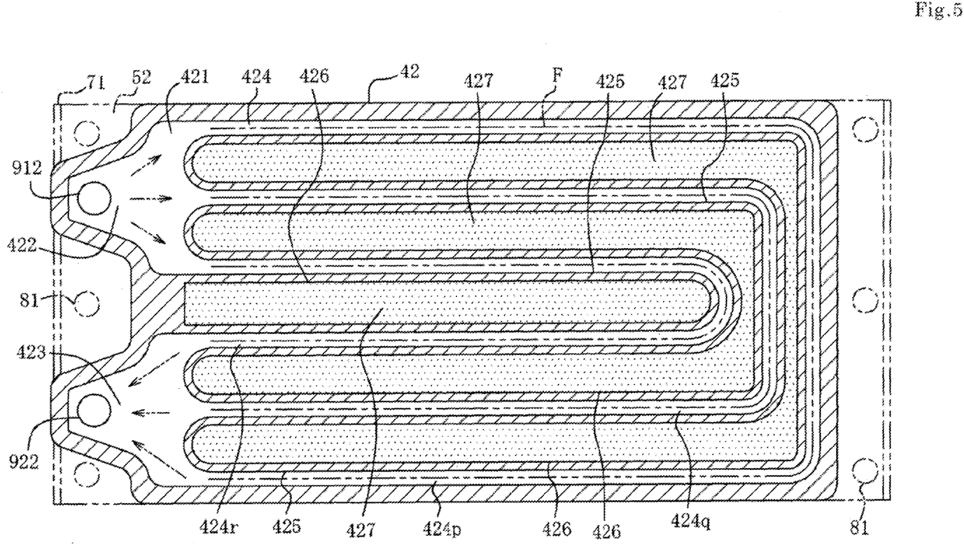

As shown in FIGS. 2 and 5, the refrigerant F such as cooling water supplied by the fluid supply pipe 91 is distributed by flowing into the respective heat exchange panels 42 from the inlet port 422 communicating with the protruding pipe 913. The refrigerant F circulates in the heat exchange panel 42 along the heat exchange surface 421, and is discharged to the outside through the fluid discharge pipe 92 so as to be collected in the fluid discharge pipe 92 from the outlet port 423 communicating with the protruding pipes 923 of the respective heat exchange panels 42. When the heat exchange panel 42 is, for example, a thin panel having a thickness of 4 mm or less, the installation space can be satisfactorily saved.

A flow path 424 through which the refrigerant F circulates along the heat exchange surface 421 is provided in the heat exchange panel 42, and the flow path 424 is defined by flow path walls 425. In the example of FIG. 5, three branch flow paths 424p, 242q, and 424r are formed in the flow path 424, and the branch flow paths 424p, 242q, and 424r circulate the refrigerant F along the heat exchange surface 421. The flow path 424 or the branch flow paths 424p, 242q, and 424r allow the refrigerant F to circulate along the heat exchange surface 421 over substantially the entire heat exchange surface 421.

A storage space 426 surrounded by the flow path walls 425 is filled with a latent heat storage material 427 that undergoes a phase change (phase transition) at a temperature lower than the temperature of the refrigerant F when the refrigerant is supplied. In the example of FIG. 5, two storage spaces 426 substantially U-shaped in a plan view of the heat exchange panel 42 are provided. Furthermore, a storage space 426 is formed near the in-course of the refrigerant circulation and a storage space 426 is formed near the out-course of the refrigerant circulation. In addition, one substantially rectangular storage space 426 is provided inside the flow path wall 425 provided so as to extend horizontally from the side of the inlet port 422 and the outlet port 423 to form a central partition wall, and the storage spaces 426 are filled with the latent heat storage material 427.

In other words, in this example, the storage space 426 filled with the latent heat storage material 427 is provided between the branch flow path 424p and the branch flow path 424q and between the branch flow path 424q and the branch flow path 424r. In addition, the storage space 426 filled with the latent heat storage material 427 is provided in the central partition wall configured by the flow path wall 425 and configured to circulate the refrigerant F. Each storage space 426 is surrounded and partitioned by the flow path wall 425 over the entire circumference, and is sealed. As the refrigerant F, an applicable low-temperature liquid or gas can be used. For example, it is preferable to use cooling water or the like. An appropriate latent heat storage material that undergoes a phase change (phase transition) at a temperature lower than the temperature of the refrigerant F when the refrigerant is supplied can be used as the latent heat storage material 427. For example, a paraffin-based latent heat storage material that undergoes a phase change at a specific temperature within the temperature range of 5° C. to 20° C. is preferably used.

The insulating container main body 2 is provided with a plurality of penetrating portion 24 formed by fixing a short cylinder or the like so as to maintain a closed state of the insulating space S1 between the inner wall 21 and the outer wall 22. The fluid supply pipe 91 and the fluid introduction pipe 911 are provided so as to penetrate the penetrating portions 24. In this way, the fluid supply pipe 91 and the fluid discharge pipe 92 are connected to the inside and outside of the insulating container 1 through the penetrating portion 24.

Around the penetrating portion 24, a substantially concave cap 10 is fixed to the outer surface of the insulating container 1 with the concave side facing the outer surface of the insulating container 1. In the present embodiment, the cap 10 is fixed by welding or the like to the outer surface of the outer wall 22 of the insulating container main body 2. An insertion hole 101 is formed substantially in the center of the cap 10, and the fluid introduction pipe 911 and the fluid lead-out pipe 921 are inserted into the insertion hole 101. An insulating space S4 surrounded by the cap 10, the outer surface of the outer wall 22, and the outer surface of the fluid introduction pipe 911 or the fluid lead-out pipe 921 is provided on the concave side of the substantially concave cap 10 (in the shown example, the bowl-shaped cap 10).

According to the battery heat exchange structure of this embodiment, since the battery cell 41 and the heat exchange panel 42 are in close contact with each other so that the side surface 411 of a necessary battery cell 41 follows the heat exchange surface 421 of the heat exchange panel 42, heat exchange between the latent heat storage material 427 in the heat exchange panel 42 and the battery cell 41 and between the battery cell 41 and the refrigerant F circulating through the heat exchange panel 42 can be performed with high heat exchange efficiency. Furthermore, at low temperatures, excessive temperature drops in the battery cells 41 can be suppressed by exchanging heat with the heat released by the phase change of the latent heat storage material 427, and a temporary decrease in battery performance due to a decrease in output voltage and a decrease in discharge capacity can be prevented. In addition, at high temperatures, excessive temperature rise in the battery cells 41 can be suppressed by exchanging heat with the refrigerant F circulating through the heat exchange panel 42, and permanent deterioration of battery performance and shortening of battery life can be prevented. That is, the temperature of the battery can be controlled to be within an appropriate temperature range.

Further, the flow path 424 has three or more branch flow paths 424p, 242q, and 424r, each of the branch flow paths 424p, 242q, and 424r is provided so as to circulate the refrigerant F along the heat exchange surface 421, and the storage space 426 filled with the latent heat storage material 427 is provided at least between the branch flow paths. Therefore, with respect to the heat exchange surface 421 of the heat exchange panel 42, for example, the region corresponding to the arrangement of the latent heat storage material 427, such as a latent heat storage material having a lower thermal conductivity than the refrigerant, can be more evenly distributed, and the region corresponding to the circulation of the refrigerant F can be more evenly distributed. Furthermore, the heat exchange that suppresses an excessive temperature drop at low temperatures and the heat exchange that suppresses an excessive temperature rise at high temperatures can be performed more reliably. Therefore, the temperature of the battery can be reliably controlled to be within an appropriate temperature range.

Further, the heat exchange panel 42 and the battery cell 41 are elastically urged so as to be compressed and pressed in the arrangement direction, the heat exchange efficiency between the latent heat storage material 427 in the heat exchange panel 42 and the battery cell 41 and the heat exchange efficiency between the battery cell 41 and the refrigerant F circulating through the heat exchange panel 42 can be further improved, and the stability of heat exchange can be enhanced. Further, since the heat exchange panel 42 and the battery cell 41 are elastically urged in the arrangement direction, it is possible to secure a state in which the heat exchange panel 42 and the battery cell 41 are pressed in the arrangement direction following the thermal expansion of the battery and the contraction when the temperature drops. In addition, since the heat exchange panel 42 and the battery cell 41 are elastically urged in the arrangement direction, it is possible to absorb the amount of expansion during thermal expansion of the battery, prevent damage to the heat exchange structure due to an increase in internal pressure, and improve safety.

The heat exchange surface 421 of the heat exchange panel 42 can be pressed substantially uniformly against the side surface 411 of the battery cell 41 via the holding plates 51 and 52 by the urging of the coil spring 86, the heat exchange efficiency between the battery cell 41 and the refrigerant F of the heat exchange panel 42 can be further improved, and the stability of heat exchange can be further improved.

Since a portion of the fluid supply pipe 91 and a portion of the fluid discharge pipe 92 are provided so as to follow the arrangement direction of the battery cell 41 and the heat exchange panel 42, by providing only parts and components that branch the fluid supply pipe 91 and the fluid discharge pipe 92 corresponding to the main pipe, the refrigerant F can flow into the plurality of heat exchange panels 42 and the refrigerant F can flow out from the plurality of heat exchange panels 42. Thus, it is possible to reduce the number of members, reduce the manufacturing cost, and improve the efficiency of the assembly process.

Due to the elastic connecting pipe 912 corresponding to the part of the fluid supply pipe 91 between the heat exchange panels 42 and 42 and the elastic connecting pipe 922 corresponding to the part of the fluid discharge pipe 92 between the heat exchange panels 42 and 42, the elastic tube expands to follow when the battery cell 41 thermally expands due to heat generation, and elastically restores according to the convergence of the thermal expansion, and the thermal expansion can be absorbed by the fluid supply pipe 91 and the fluid discharge pipe 92.

Since the battery body 4 including the battery cell 41 and the heat exchange panel 42 and the support portion for supporting the battery body 4 are housed in the insulating container 1, the influence of the temperature of the external environment on the battery can be reduced. The range of the low temperature level that can be handled in a low-temperature external environment and the range of the high temperature level that can be handled in a high-temperature external environment can be extended. Furthermore, the temperature range in which the temperature of the battery can be controlled to be within an appropriate temperature range can be extended. In addition, when the battery body is equipped with a protection circuit that regulates the output at a very high temperature, it is possible to prevent the protection circuit from operating unexpectedly at a very high temperature in the summer. In particular, in the present embodiment, since the insulating spaces S1 and S2 are provided in the insulating container 1 and the battery body 4 is housed in the insulating container 1 so as to be spaced apart from the insulating container 1, these effects can be further enhanced.

In addition, when the temperature of the battery cell 41 in a low temperature state is raised to an appropriate temperature range, since the temperature can be raised without using the heating of the heater that uses the electric power of the battery, it is possible to prevent a decrease in the cruising distance of an automobile, for example. The heat collected via the refrigerant F by the heat exchange between the high-temperature battery cell 41 and the refrigerant F can be supplied to the battery or other places where heat is needed when necessary by a heat storage device or the like separately provided.

### Scope of Inclusion of Invention Disclosed in Present Specification

The invention disclosed in the present specification includes each invention and each embodiment, and, within an applicable range, an invention specified by changing a partial configuration thereof to another configuration disclosed in the present specification, an invention specified by adding another configuration disclosed in the present specification to the configuration thereof, and an invention obtained by reducing, specifying and highly conceptualizing the partial configuration thereof as long as a partial effect is acquired. The invention disclosed in the present specification includes the following modified embodiments and postscripts.

For example, the insulating container in which the battery cell and the heat exchange panel of the present invention are housed is preferably the insulating container 1 of the above-described embodiment, but they can also be housed in an insulating container other than the insulating container 1 of the above-described embodiment. The present invention also includes a configuration in which the battery cell and the heat exchange panel of the present invention are not housed in the insulating container.

The shape and number of penetrating portions 24 provided in the double wall of the insulating container 1 with the insulating spaces S1 and S2 closed may be changed appropriately. For example, the penetrating portion 24 through which the battery cable is passed, the penetrating portion 24 through which the fluid supply pipe 91 is passed, and the penetrating portion 24 through which the fluid discharge pipe 92 is passed may be provided individually. Alternatively, both the battery cable and the fluid supply pipe 91 or the fluid discharge pipe 92 may be passed through one penetrating portion 24.

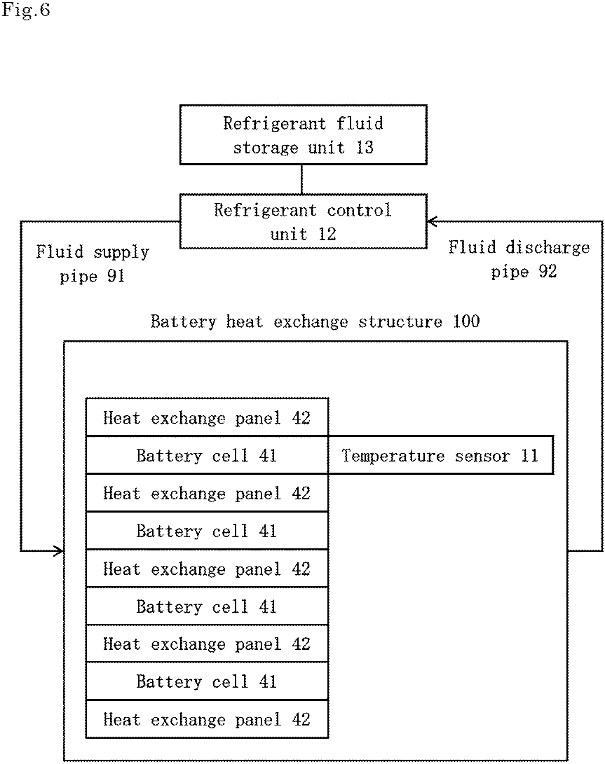

In the battery heat exchange structure of the present invention, as shown in FIG. 6, it may be preferable that a temperature sensor 11 for detecting the temperature of the battery cell 41 of the battery heat exchange structure 100 is provided close to the battery cell 41, and a refrigerant control unit 12 supplies the refrigerant F having a required temperature of a refrigerant storage unit 13 according to the detection temperature from the temperature sensor 11. In this way, the refrigerant F having a required temperature can be circulated as necessary according to the detection temperature from the temperature sensor 11, and the temperature of the battery can be automatically controlled to be in an appropriate temperature range. The communication between the refrigerant control unit 12 and the temperature sensor 11 can be performed by wired communication using a cable provided through the penetrating portion 24 or wireless communication or the like.

The battery heat exchange structure of the present invention is not limited to the configuration in which the battery cell 41 and the heat exchange panel 42 of the above-described embodiment are closely and alternately arranged side by side. The battery heat exchange structure of the present invention includes a structure in which the battery cell and the heat exchange panel are closely arranged side by side so that the heat exchange surface of the heat exchange panel follows the side surface of the battery cell. As a preferred example, even when the battery cell and the heat exchange panel are closely arranged side by side so that the heat exchange surface of the heat exchange panel follows the side surface of one or both battery cells at every other location between the battery cells, the required heat exchange property can be obtained. In addition, even when the battery cell and the heat exchange panel are closely arranged side by side so that the heat exchange surface of the heat exchange panel follows the side surface of one or both battery cells at a small number of locations such as two or three locations smaller than the locations between the plurality of battery cells such as one, two, or three locations among all locations between the plurality of battery cells, it is possible to reduce the cost and the weight of the fluid for the heat exchange.

### Industrial Applicability

The present invention can be used, for example, when performing heat exchange with respect to a battery of an electric vehicle or the like.

Reference Signs List

| | |
|---|---|
| 1 | Insulating container |
| 2 | Insulating container main body |
| 21 | Inner wall |
| 211 | Bottom portion |
| 212 | Peripheral side portion |
| 213 | Flange |
| 22 | Outer wall |
| 221 | Bottom portion |
| 222 | Periphelral side portion |
| 223 | Flange |
| 23 | Container-side flat flange |
| 24 | Penetrating portion |
| 3 | Insulating lid |
| 31 | Inner lid |
| 311 | Substrate |
| 312 | Erected portion |
| 313 | Flange |
| 32 | Outer lid |
| 33 | Lid-side flat flange |
| 4 | Battery body |
| 41 | Battery cell |
| 411 | Side surface |
| 42 | Heat exchange panel |
| 421 | Heat exchange surface |
| 422 | Inlet port |
| 423 | Outlet port |
| 424 | Flow path |
| 424p, 424q, 424r | Branch flow path |
| 425 | Flow path wall |
| 426 | Storage space |
| 427 | Latent heat storage material |
| 51, 52 | Holding plate |
| 61, 71 | Support stay |
| 62, 72 | Insulating material |
| 63, 73 | Bolt |
| 81 | Shaft bolt |
| 82, 83, 84 | Nut |
| 85 | Washer |
| 86 | Coil spring |
| 91 | Fluid supply pipe |
| 911 | Fluid lead-out pipe |
| 912 | Connecting pipe |
| 913 | Protruding pipe |
| 92 | Fluid dicharge pipe |
| 921 | Fluid lead-out pipe |
| 922 | Connecting pipe |
| 923 | Protruding pipe |
| 10 | Cap |
| 101 | Insertion hole |
| 100 | Battery heat exchange structure |
| 11 | Temperature sensor |
| 12 | Refrigerant control unit |
| 13 | Refrigerant fluid storage unit |
| S1, S2, S3, S4 | Insulating space |
| F | Refrigerant |

1-5. (canceled)

6. A battery heat exchange structure, wherein
a battery cell and a heat exchange panel are closely arranged side by side so that a heat exchange surface of the heat exchange panel follows a side surface of the battery cell,
a flow path wall defining a flow path through which a refrigerant circulates along the heat exchange surface is provided in the heat exchange panel, and
a storage space surrounded by the flow path wall is filled with a latent heat storage material that undergoes a phase change at a temperature lower than the temperature of the refrigerant when the refrigerant is supplied.

7. The battery heat exchange structure according to claim 6, wherein
the flow path has three or more branch flow paths,
each of the branch flow paths is provided so as to circulate the refrigerant along the heat exchange surface, and
the storage space filled with the latent heat storage material is provided at least between the branch flow paths.

8. The battery heat exchange structure according to claim 6, wherein
the heat exchange panel and the battery cells are elastically urged so as to be compressed in the arrangement direction of the heat exchange panel and the battery cell.

9. The battery heat exchange structure according to claim 7, wherein
the heat exchange panel and the battery cells are elastically urged so as to be compressed in the arrangement direction of the heat exchange panel and the battery cell.

10. The battery heat exchange structure according to claim 6, wherein
a battery body including the battery cell and the heat exchange panel, and a support portion supporting the battery body are housed in a heat insulating container.

11. The battery heat exchange structure according to claim 7, wherein
a battery body including the battery cell and the heat exchange panel, and a support portion supporting the battery body are housed in a heat insulating container.

12. The battery heat exchange structure according to claim 8, wherein
a battery body including the battery cell and the heat exchange panel, and a support portion supporting the battery body are housed in a heat insulating container.

13. The battery heat exchange structure according to claim 9, wherein
a battery body including the battery cell and the heat exchange panel, and a support portion supporting the battery body are housed in a heat insulating container.

14. The battery heat exchange structure according to claim 6, wherein
a temperature sensor for detecting a temperature of the battery cell is provided close to the battery cell, and
a refrigerant control unit supplies the refrigerant having a required temperature according to a detection temperature from the temperature sensor.

15. The battery heat exchange structure according to claim 7, wherein
a temperature sensor for detecting a temperature of the battery cell is provided close to the battery cell, and
a refrigerant control unit supplies the refrigerant having a required temperature according to a detection temperature from the temperature sensor.

16. The battery heat exchange structure according to claim 8, wherein
a temperature sensor for detecting a temperature of the battery cell is provided close to the battery cell, and
a refrigerant control unit supplies the refrigerant having a required temperature according to a detection temperature from the temperature sensor.

17. The battery heat exchange structure according to claim 9, wherein
a temperature sensor for detecting a temperature of the battery cell is provided close to the battery cell, and
a refrigerant control unit supplies the refrigerant having a required temperature according to a detection temperature from the temperature sensor.

18. The battery heat exchange structure according to claim 10, wherein
a temperature sensor for detecting a temperature of the battery cell is provided close to the battery cell, and
a refrigerant control unit supplies the refrigerant having a required temperature according to a detection temperature from the temperature sensor.

19. The battery heat exchange structure according to claim 11, wherein
a temperature sensor for detecting a temperature of the battery cell is provided close to the battery cell, and
a refrigerant control unit supplies the refrigerant having a required temperature according to a detection temperature from the temperature sensor.

20. The battery heat exchange structure according to claim 12, wherein
a temperature sensor for detecting a temperature of the battery cell is provided close to the battery cell, and
a refrigerant control unit supplies the refrigerant having a required temperature according to a detection temperature from the temperature sensor.

21. The battery heat exchange structure according to claim 13, wherein
a temperature sensor for detecting a temperature of the battery cell is provided close to the battery cell, and
a refrigerant control unit supplies the refrigerant having a required temperature according to a detection temperature from the temperature sensor.
